(19) United States
(12) Patent Application Publication
(10) Pub. No.: US 2005/0169581 A1
(43) Pub. Date: Aug. 4, 2005

(54) Laser diode system

(76) Inventors: Elizabeth Downing, Sunnyvale, CA (US); Juergen Bruegl, Los Altos, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 10/767,199

(22) Filed: Jan. 30, 2004

(51) Int. Cl. G02B 6/26

(52) U.S. Cl. 385/39

(57) ABSTRACT

An apparatus and method for optically aligning output beams from multiple, individual, different-wavelength laser diodes. The output of a first laser diode is fed directly into the high-reflector of a laser diode, through the gain medium, and is output from an output coupler in each of a sequence of abutting laser diodes. The output from the last laser diode includes the individual beams from each laser diode in the same single optical axis, while retaining the original wavelengths.

### BACKGROUND AND SUMMARY OF THE INVENTION

The present invention concerns an apparatus and method for aligning a plurality of laser beams, having different wavelengths, along a single optical axis.

There are advantages in aligning multiple lasers along the same optical path, including reducing the number of downstream optical elements, superimposing different wavelengths at the same point in a display and reducing an overall product size. However, there are significant disadvantages to the presently available systems for accomplishing the optical alignment of multiple lasers along the same optical path. One such prior art system and method for aligning multiple lasers along the same optical path is illustrated in FIG. 1. In FIG. 1 the single optical axis, formed from the three separate lasers, requires the use of two optical elements 10 and 11. During manufacture, these glass and/or plastic optical elements must be attached, fixed, glued etc, which increases the alignment difficulties and has consequent long term alignment problems. For example, in addition to the initial alignment problems and the associated cost, the glue used to hold these elements in place is subject to a long term thermally induced polymer creep resulting in an eventual misalignment. Furthermore, as the number of refractive or reflective surfaces increases as additional elements are added, due to an increase in the number of lasers, the arrangement is certainly more likely to have increased lasers and to be misaligned during the manufacturing process.

Typical packaging of an individual laser diode involves soldering of the diode. The diode itself has a coated back facet, known as the High Reflector (HR) and a coated front facet, known as the Output Coupler (OC), which are both coated with reflective materials. A diode is soldered onto a small heat sink with an attached anode wire as shown in FIG. 2. Additionally, the device of FIG. 2 may be encased in hermetic packaging to provide additional product life. Each individual packaged laser emits one predominant wavelength along an optical axis as a function of the output parameters of the laser including temperature and current. In FIG. 3, a multiplicity of laser diodes are shown aligned in a row, which diodes face in the same direction providing either synchronous or individually addressable anodes. Such devices emit light in the same direction but along a plurality of parallel optical axis. In order to provide light output from the different individual package diodes or from the array of laser diodes shown in FIG. 2 so that the light is coincident along the same optical axis, additional components such as prisms, gratings and other optical elements must be integrated into the path. This obviously increases the complexity and the cost of any such system.

The object of the present invention is to provide improved multiple laser beam alignment arrangements having not only improved alignment of laser diode outlet beams but also an improved packaging arrangement.

In accordance with the objects of the present invention, a plurality of optic beams from multiple individual different wavelength laser beams are combined without the need for additional prisms, gratings or other combining elements.

According to the present invention, this is accomplished by arranging a plurality of laser diodes one behind the other such that their respective optical axes are coincident. No stimulation of laser action occurs between the sequentially packaged lasers, as the lasers of the present invention do not interact optically with each other but rather simply confine the light. The packaging of lasers directly behind one another for purposes of stimulating laser action between sequentially packaged lasers is known, for example, from a Master-Oscillator Power-Amplifier (MOPA) shown in FIG. 7. A single Fabre-Perot device (oscillator) is packaged directly behind another laser diode (amplifier). The second laser diode is longer than the first in order to provide more gain and the oscillator is not coated with reflective coating so that it does not have the High Reflector-HR or the Output Coupler (OC) coating. Light from the oscillator of FIG. 4 seeds the amplifier chip, pulling massive gain out of the second device in a single pass (no oscillation). These devices were developed to enable high speed modulation of high power by modulating the low current to the oscillator. The present invention differs from the MOPA architecture in that the output of one laser is not used to stimulate gain of the same wavelength in an amplifier. Instead, the present invention provides a single optical axis for a plurality of different wavelengths.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates a prior art method for aligning multiple lasers along a single optical path;

FIG. 2 is an arrangement of a single laser diode mounted on a heat sink;

FIG. 3 is a schematic of an array of laser diodes mounted in parallel;

FIG. 4 is a prior art diode structure for amplifying a single wavelength;

FIGS. 5 and 5b show an axial array of laser diodes mounted on a heat sink according to the present invention;

FIG. 6 illustrates an axial array according to the present invention using broad area emitters;

FIG. 7 details the application of the present invention to a parallel array of axially-aligned laser diodes mounted on a heat sink;

FIG. 8 illustrates scanning of an axial array of laser diodes into an optical fiber for a micro-electro-mechanical-system (MEMS) or other scanning device.

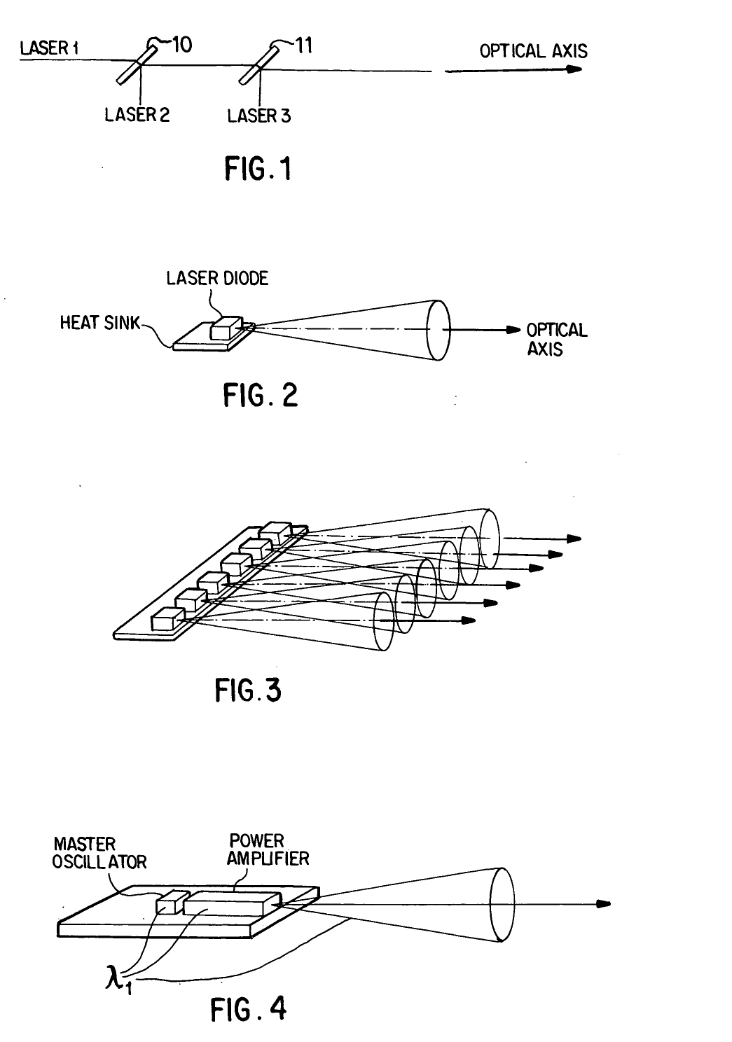

### DETAILED DESCRIPTION OF THE PREFERRED EMBODIMENTS

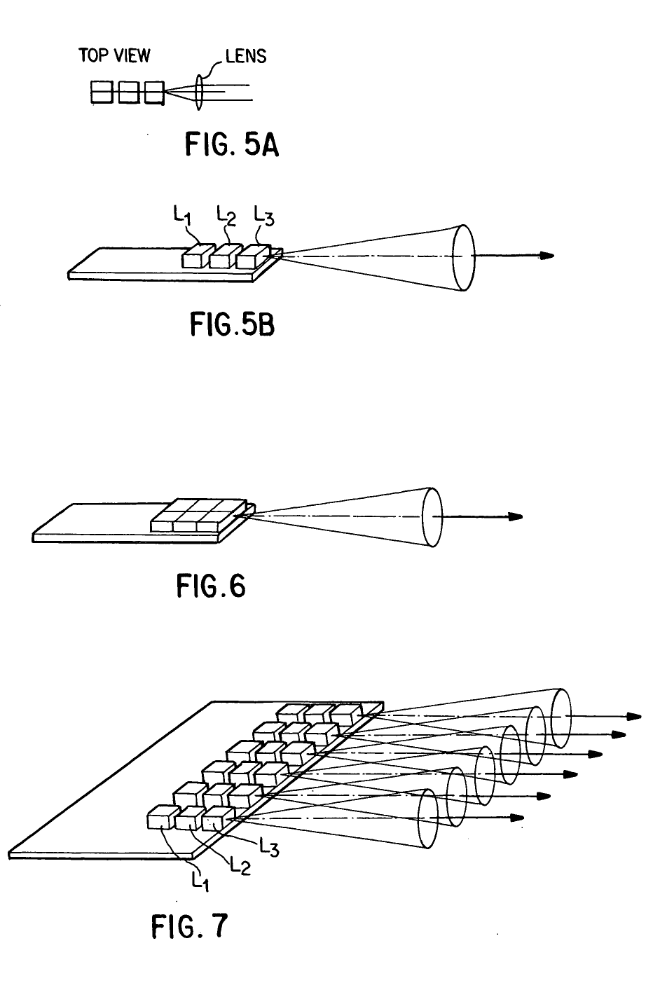

The optical alignment of output beams from multiple individual different-wavelength laser diodes L1, L2 and L3 is shown in FIGS. 5a and 5b. Light output from first laser diode L1 passes directly into the high reflector (HR) of a second laser diode L2 through the gain medium and out from the Output Coupler (OC). Additionally, the emission of the second laser L2 is also output from the OC of the second laser. The coincident beams of lasers L1 and L2 are then directed into the High-Reflector (HR) and out from the Output Coupler (OC) of an additional laser diode L3 in a sequential fashion. The light from the Output Coupler of laser diode L3 thus includes superimposed beams from all three lasers (L1, L2, L3), which are aligned on a single optical axis. Light will propagate through the entire structure in a manner similar to the manner in which light passes through an optical fiber provided that individual laser diodes L1-L3 are directly adjacent to each other or separated by a very small distance. The beam from L1 passes directly through L2 and L3 and the beam from L2 passes directly through L3 along with the light beam emitted from L3. Therefore, all beams exit from the Output Coupler of the final diode L3, having diffraction properties of the final exit aperture yet retaining their original individual wavelengths.

The functioning of the different wavelength laser diodes to provide optical alignment of the output beams results from the stacked mirror coatings which make up the HR (high-reflector) and the OC (output coupler) of the diode, which have a very narrow band of reflectivity (typically less than 10 nm FWHM (Full Width Half Minimum)). The end or facet coatings are transparent outside of the particular narrow band region thereby allowing light of other wavelengths to pass directly through the diode structure without heating up the surfaces, without lasing or oscillating, without depleting gain, or without interfering with the internal mode structure. Additionally, a sequential laser, which is confined within a structure, functions to prevent diffraction of an incident laser beam until it exits from the last output coupler (OC). In this way, multiple lasers can be packaged on the same heat sink while being placed next to each other in a serial fashion in order to optically superimpose the outputs.

The alignment mechanism described above and shown in FIG. 5 can be used on a variety of structures including, but not limited to, standard Fabre-Perot lasers, and broad-beam emitters as shown in FIG. 6. Furthermore, it is possible to construct arrays of such devices as shown in FIG. 7.

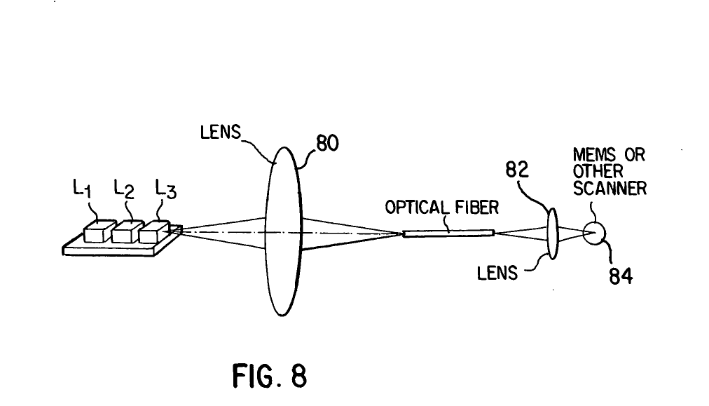

FIG. 8 illustrates axially aligned laser diodes according to the present invention coupled into an optical fiber through the lens 80 and from the fiber through lens 82 into a scanner 84. An optical system according to the present invention provides low-cost optical subassemblies for laser projection displays and up- or down-conversion displays which are designed for automobiles. The invention may also be used in telecommunication systems, laser printing, volumnmetric displays and other products that incorporate laser diodes of multiple, differing wavelengths.

The simplicity and the ability to be implemented during the packaging of the lasers are just a few of the several advantages the present invention offers over existing methods of optically aligning multiple laser beams. It is not only cost effective but can also be used to align different wavelengths of laser diodes into a single device architecture, which is needed for MEMS (micro-electro-mechanical-system) projection display technology used in automobiles and other areas such as consumer electronics or telecommunication.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A laser diode system for propagating multiple laser beams of different wavelengths along the same optical axis, the system comprising:
at least two laser diodes, each of said laser diodes including a first reflective coating on a back facet and a second reflective coating on a front facet; and
laser support structure for supporting said at least two laser diodes in a substantial abutting relationship, wherein each of said at least two laser diodes output a wavelength different from any other one of said at least two laser diodes and wherein an output of one of said at least two laser diodes provides a laser output containing beams from each of said at least two laser diodes, said contained beams retaining their original wavelengths and being aligned in the same optical axis.

2. The system according to claim 1, wherein said laser support is a heat sink.

3. The diode system according to claim 1, wherein the first and second reflective coatings of the front facet and the rear facet provide very narrow band reflectivity with said coatings being transparent outside of said narrow band thereby allowing light of wavelengths outside said narrow band to pass directly through the diode.

4. The system according to claim 1, wherein diffraction properties of each of said beams in said output are identical and are provided as a function of a final exit aperture of said one laser diode.

5. The system according to claim 1, wherein each of said at least two laser diodes are Fabre-Perot lasers.

6. The system according to claim 1, wherein each of said at least two lasers are broad-area emitter lasers.

7. A method for aligning multiple laser beams along an optical axis, the method comprising the acts of:
providing a plurality of laser diodes;
coating a back facet and a front facet of each of said plurality of diodes;
arranging said plurality of diodes in a substantially sequential relationship on a support structure whereby a resulting laser output contains a laser beam output from each of said plurality of diodes and wherein each of said output laser beams is aligned in a same single optical axis.

8. The method according to claim 7, further including fixing each of said laser diodes onto a heat sink.

9. The method according to claim 8, further including hermetically encasing said plurality of laser diodes on said heat sink.

10. The method according to claim 7, wherein said coated front and rear facet of said plurality of diodes provides a narrow band reflectivity, which allows light of wavelengths outside said narrow band to pass directly through.

11. An optically aligned arrangement of laser diodes, comprising:
a plurality of laser diodes with each of said laser diodes outputting different wavelengths;
a support device retaining said plurality of laser diodes in a series of back-two-back substantially abutting relationships, each of said plurality of laser diode having front and back coated facets wherein one of said plurality of laser diodes outputs a plurality of laser beams wherein each of said plurality of laser beams respectively corresponds to each of said plurality of laser diodes and wherein each of said laser beams proceeds from said one laser diode in a single same optical axis.

12. The arrangement according to claim 11, wherein said support device is a heat sink.

13. The arrangement according to claim 11, wherein said output beams provide an optical fiber input.

14. The arrangement according to claim 13, further including an optical fiber for receiving said optical fiber input and outputting a fiber output to a scanning device.

15. The arrangement according to claim 13, further including an optical fiber for receiving said optical fiber input and providing an output to a micro-electro-mechanical-system projection display device.

16. A laser diode system, comprising:
at least two individual laser diodes aligned one behind the other, a first of said two laser diodes outputting a first laser beam of a first wavelength along an optical axis into a second of said two laser diodes; and
wherein the second laser diode outputs a laser beam containing the first and a second, different, wavelength along the optical axis.
